(19) United States
(12) Patent Application Publication
(10) Pub. No.: US 2019/0225734 A1
(43) Pub. Date: Jul. 25, 2019

(54) SUSTAINABLE POLYOL BLENDS FOR HIGH-PERFORMANCE COATINGS

(71) Applicant: Resinate Materials Group, Inc., Plymouth, MI (US)

(72) Inventors: Rick Tabor, Plymouth, MI (US); Matthew J. Beatty, Ann Arbor, MI (US); Gary E. Spilman, Northville, MI (US); Shakti L. Mukerjee, Canton, MI (US)

(21) Appl. No.: 16/314,793

(22) PCT Filed: Jun. 23, 2017
(86) PCT No.: PCT/US2017/039065

§ 371 Date: Jan. 2, 2019

Related U.S. Application Data
(60) Provisional application No. 62/359,966, filed on Jul. 8, 2016.

(51) Int. Cl. C08G 18/42; C08G 18/66; C08G 18/72; C08G 18/73; C09D 175/06; C08K 5/053; C08K 5/1535; C08K 5/1515

(52) U.S. Cl. CPC C08G 18/4252; C08G 18/6644; C08G 18/722; C08G 18/73; C08K 5/1515; C08G 18/4208; C09D 175/06; C08K 5/053; C08K 5/1535; C08G 18/425

(57) ABSTRACT

Polyester polyol blends are disclosed. The blends comprise 70 to 99 wt. % of an aromatic or aliphatic polyester polyol, 0.1 to 10 wt. % of a sugar having an average hydroxyl functionality of 4 to 6 and a melting point less than 125° C., and 1 to 20 wt. % of a glycidyl compound having a boiling point of at least 200° C. at 760 mm Hg. The polyester polyol can be made by glycolysis of a recycled thermoplastic polymer, such as polyethylene terephthalate. The polyol blends are useful for the production of polymeric coatings and other products. Coatings made from blends of the polyester polyols and 0.1 to 10 wt. % of a sugar are also described.

### FIELD OF THE INVENTION

The invention relates to polyester polyol blends. The blends are useful for formulating high-performance polyurethane coatings and other products.

### BACKGROUND OF THE INVENTION

Polyester polyols, especially aromatic polyester polyols, are widely used in the production of rigid foams as well as coatings, adhesives, sealants, and elastomers (“CASE” applications). Polyurethane formulators often prefer higher molecular weight polyols as a way to reduce the demand for the more costly polyisocyanate component. Particularly in the manufacture of polyurethane coatings it can be challenging to produce high-quality coatings from such polyester polyols because of their high viscosities.

High-functionality polyether polyols having an average of 4-8 hydroxyl groups per molecule are often made using sorbitol, sucrose, or other sugars as initiators, and reacting them with propylene oxide, ethylene oxide, or combinations thereof. For examples of sugar-initiated polyols, see U.S. Pat. Nos. 5,008,299, 5,373,030, 5,922,779, and U.S. Publ. Nos. 2013/0030067 and 2015/0051304. Sugars have also been reacted with dicarboxylic acids or anhydrides to make polyester polyols having high functionality (see, e.g., U.S. Pat. Nos. 5,332,860, 6,664,363, and 6,613,378). In some cases, reaction products of sugars with glycol-digested polyethylene terephthalate have been described (see, e.g., U.S. Pat. No. 4,604,410).

Less frequently, sugars have simply been blended with polyester polyols for use in the production of rigid polyurethane or polyisocyanurate foams, elastomers, and other products (see, e.g., WO 2004/005365, U.S. Publ. No. 2004/0157945, and K. Kizuka et al., J. Org. Polym. Mat. 5 (2015) 103). In such blends of polyester polyols and sugars, glycidyl ethers have apparently not been included.

Glycidyl compounds, particularly glycidyl ethers and esters, are well-known reactive diluents. They are commonly used in formulations with an epoxy resin (or a diglycidyl ether) and an amine-functional curative (or “hardener”). The glycidyl ether or ester helps to control viscosity and/or formulation working time (or “pot life”). Glycidyl ethers and esters have been blended on occasion with polyester polyols, but sugars have not been included in those blends.

A need remains for improved polyester polyol blends, particularly blends that include polyester polyols with relatively high molecular weight. A valuable blend would allow formulators to boost the hydroxyl functionality of the polyol component while maintaining a workable viscosity. Ideally, the blends could provide high-quality polyurethane coatings with improved hardness, adhesion, solvent resistance, and other properties.

### SUMMARY OF THE INVENTION

In one aspect, the invention relates to a polyol blend. The blend comprises (a) 70 to 99 wt. % of an aromatic or aliphatic polyester polyol; (b) 0.1 to 10 wt. % of a sugar having an average hydroxyl functionality of 4 to 6 and a melting point less than 125° C.; and (c) 1 to 20 wt. % of a glycidyl compound selected from the group consisting of glycidyl ethers, diglycidyl ethers, glycidyl esters, diglycidyl esters, and mixtures thereof, wherein the glycidyl compound has a boiling point of at least 200° C. at 760 mm Hg.

The polyol blends are useful for the production of polyurethane and polyisocyanurate products. Thus, in another aspect, the invention relates to a two-component polyurethane coating made from the polyester polyol blend described above and one or more diisocyanates or a diisocyanate trimer. Moisture-cured polyurethane coatings, rigid polyurethane or polyisocyanurate foams, flexible polyurethane foams, polyurethane adhesives, polyurethane dispersions, and acrylates or urethane acrylates made from the polyol blends are also contemplated.

We surprisingly found that certain blends of an aromatic or aliphatic polyester polyol, a sugar, and a glycidyl compound are valuable for formulating polyurethane products, especially coatings, and that the resulting coatings display a synergistic boost in certain properties, notably hardness, adhesion, and solvent resistance while retaining good film quality.

In another aspect, the invention relates to polymer coatings made from blends of an aromatic or aliphatic polyester polyol and a sugar. Coatings from these blends display good hardness, good flexibility, and improved adhesion and solvent resistance when compared with similar coatings made from the polyester polyol alone.

### DETAILED DESCRIPTION OF THE INVENTION

### I. Polyol Blends

A. The Polyester Polyol Component

Polyol blends of the invention comprise 70 to 99 wt. %, based on the amount of polyol blend, of an aromatic or aliphatic polyester polyol. Some polyol blends comprise 75 to 98 wt. % or 80 to 95 wt. % of the aromatic or aliphatic polyester polyol.

Suitable aromatic and aliphatic polyester polyols are well known and can be purchased or synthesized. Suitable commercially available polyester polyols include, for example, Stepanpol® polyols (Stepan Company), Terate® polyols (Invista), Desmophen® polyols (Covestro), and Terol® polyols (Huntsman). Mixtures of aromatic and aliphatic polyester polyols can be used.

Suitable aromatic and aliphatic polyester polyols can also be synthesized by well-known condensation polymerization techniques from dicarboxylic acids, esters, or anhydrides (e.g., phthalic anhydride, phthalic acid, isophthalic acid, terephthalic acid, dimethyl terephthalate, adipic acid, succinic acid, maleic anhydride, glutaric acid, maleic acid, fumaric acid, itaconic acid, itaconic anhydride, 1,5-furandicarboxylic acid, and the like) and diols (ethylene glycol, propylene glycol, 1,3-propanediol, 1,2-butylene glycol, 1,3-butylene glycol, diethylene glycol, dipropylene glycol, triethylene glycol, tripropylene glycol, tetraethylene glycol, 1,4-butanediol, 2-methyl-1,3-propanediol, 3-methyl-1,5-pentanediol, 1,6-hexanediol, neopentyl glycol, glycerol, trimethylolpropane, 2,2,4,4-tetramethyl-1,3-cyclobutanediol, bisphenol A ethoxylates, 1,4-cyclohexanedimethanol, 1,3-cyclohexanedimethanol, and the like).

In one aspect, the polyester polyol is produced by glycolysis of a recycled thermoplastic polyester. Suitable thermoplastic polyesters include polyethylene terephthalate; polybutylene terephthalate; polytrimethylene terephthalate; glycol-modified polyethylene terephthalate; copolymers of terephthalic acid and 1,4-cyclohexanedimethanol; isophthalic acid-modified copolymers of terephthalic acid and 1,4-cyclohexanedimethanol; polyhydroxy alkanoates; copolymers of diols with 2,5-furandicarboxylic acid or dialkyl 2,5-furandicarboxylates; copolymers of 2,2,4,4-tetramethyl-1,3-cyclobutanediol with isophthalic acid, terephthalic acid or orthophthalic acid derivatives; dihydroferulic acid polymers; and mixtures thereof. In a preferred aspect, the thermoplastic polyester is recycled polyethylene terephthalate (“rPET”).

The thermoplastic polyester can be reacted with a glycol, with or without a catalyst present, to give a digested reaction product that can function as a polyester polyol in the inventive polyol blends. Suitable glycols for use in producing the glycol-digested thermoplastic polyester include, for example, ethylene glycol, propylene glycol, 1,3-propanediol, 1,2-butylene glycol, 1,3-butylene glycol, 1,4-butanediol, 2-methyl-1,3-propanediol, pentaerythritol, sorbitol, neopentyl glycol, glycerol, trimethylolpropane, 2,2,4,4-tetramethyl-1,3-cyclobutanediol, 3-methyl-1,5-pentanediol, bisphenol A ethoxylates, 1,4-cyclohexanedimethanol, 1,3-cyclohexanedimethanol, diethylene glycol, dipropylene glycol, triethylene glycol, 1,6-hexanediol, tripropylene glycol, tetraethylene glycol, polyethylene glycols having a number average molecular weight up to about 400 g/mol, block or random copolymers of ethylene oxide and propylene oxide, and the like, and mixtures thereof.

Suitable polyester polyols for use herein preferably have number average molecular weights within the range of 140 to 22,400 g/mol, preferably 190 to 4490 g/mol. The polyester polyols preferably have hydroxyl numbers within the range of 5 to 800 mg KOH/g, more preferably from 25 to 400 mg KOH/g, most preferably from 40 to 300 mg KOH/g.

The polyol blend can include other polyether, polylactone, or polycarbonate polyols in addition to the aromatic or aliphatic polyester polyol. Suitable polyether, polylactone, and polycarbonate polyols are well known in the art.

B. The Sugar Component

The inventive polyol blends include 0.1 to 10 wt. %, 0.2 to 8 wt. %, or 0.5 to 5 wt. %, based on the amount of polyol blend, of a sugar. Suitable sugars have an average hydroxyl functionality of 4 to 6 and a melting point less than 125° C. The nature and the amount of sugar component used will depend on the desired viscosity of the polyol blend, the degree of crosslinking desired, the nature and proportion of the aliphatic or aromatic polyester polyol used, the nature and proportion of the glycidyl or diglycidyl ether used, the intended end-use application, and other factors that are within the skilled person's discretion.

Suitable sugars include, for example, sorbitol, fructose, xylitol, meso-erythritol, arabitol, glucosamine, lyxose, rhamnose, ribose, and ribitol. Sorbitol, fructose, xylitol, and meso-erythritol are preferred. Sorbitol is particularly preferred.

As shown in the table below, each of the exemplary sugars described above has an average hydroxyl functionality within the range of 4 to 6 and a melting point less than 125° C.

| | Ave. hydroxyl | |
|---|---|---|
| Sugar | functionality | Melting point (° C.) |
| sorbitol | 6 | 110-112 |
| fructose | 5 | 103 |
| xylitol | 5 | 95-97 |
| meso-erythritol | 4 | 121 |
| arabitol | 5 | 102 |
| glucosamine | 4 | 88 |
| lyxose | 4 | 106-107 |
| rhamnose | 4 | 93-95 |
| ribose | 4 | 95 |
| ribitol | 5 | 102 |

As shown above, the sugars are generally mono- or disaccharides, preferably monosaccharides. They can exist in open or cyclic form, depending on the type of sugar. Thus, if the sugar is an aldose, for instance, it might exist in either open chain or cyclic form. Preferred sugars are polyalcohols that exist only in open-chain conformations (e.g., sorbitol, xylitol, meso-erythritol, arabitol, and ribitol).

Sugars having a melting point greater than 125° C. can be included in the polyol blends but only if they are present in minor proportion because the higher-melting sugars make it more difficult to produce homogeneous liquid polyol mixtures of low viscosity. Thus, high-melting sugars such as sucrose, maltose, lactose, or cellobiose are generally avoided.

Sugars having average hydroxyl functionalities less than 4 tend to not impart adequate crosslinking and physical properties to the polyurethanes or other resulting polymer end products, while crosslink density, melting point, or isocyanate demand can be too high when the average hydroxyl functionality exceeds 6.

In limited cases, the sugar can have or be modified to include other functional groups, including amines, ethers, esters, or other groups provided that the average hydroxyl functionality is within the range of 4 to 6.

C. The Glycidyl Compound

The inventive polyol blends include 1 to 20 wt. %, based on the amount of polyol blend, of a glycidyl compound selected from the group consisting of glycidyl ethers, diglycidyl ethers, glycidyl esters, diglycidyl esters, and mixtures thereof. This component has a boiling point of at least 200° C., preferably at least 250° C., at 760 mm Hg. The high boiling points of the glycidyl compound contribute to polyol blends that are free of VOC or hazardous air pollutant content.

Suitable glycidyl or diglycidyl ethers have one or more epoxide groups, each joined by a methylene group to an alcohol, phenol, diol, or diphenol residue. In some aspects, the glycidyl or diglycidyl ether is a reaction product of epichlorohydrin or its synthetic equivalent, preferably epichlorohydrin, with an alcohol, diol, phenol, or diphenol.

Suitable glycidyl ethers are available commercially from Emerald Performance Materials, Hexion, Aditya Birla Chemicals (Thailand), and other suppliers. Examples include some aliphatic mono-functional glycidyl ethers, such as the Erisys™ GE-6 through GE-8 products from Emerald, which include 2-ethylhexyl glycidyl ether, and glycidyl ethers made from C₈-C₁₀ or C₁₂-C₁₄ alcohol streams. Aromatic mono-functional glycidyl ethers such as Erisys™ GE-11 through GE-13 are also suitable; these include, e.g., glycidyl ethers from phenols such as p-tert-butyl phenol, o-cresol, p-nonylphenol, and phenol. Diglycidyl ethers are also commercially available. Examples include Erisys™ GE-20 through GE 25 and Eyisys™ EGDGE. These include, for example, diglycidyl ethers from neopentyl glycol, 1,4-cyclohexanedimethanol, dipropylene glycol, ethylene glycol, 1,4-butanediol, 1,6-hexanediol, and polypropylene glycol. Suitable diglycidyl ethers include bisphenol-based epoxy resins such as Epon® liquid epoxy resins from Hexion, such as Epon® resins 825, 826, 828, or 830 (from bisphenol A and epichlorohydrin), or Epon® resins 862 or 863 (from bisphenol F and epichlorohydrin). Suitable glycidyl and diglycidyl ethers, even if not commercially available, are readily synthesized by reacting an alcohol, diol, phenol, or diphenol with a suitable proportion of epichlorohydrin or its synthetic equivalent according to well-known methods (see, e.g., U.S. Pat. Nos. 4,284,573; 3,372,442; 2,943,095, and references cited therein, the teachings of which are incorporated herein by reference).

Thus, in some aspects, the glycidyl or diglycidyl ether is selected from the group consisting of 2-ethylhexyl glycidyl ether, phenyl glycidyl ether, benzyl glycidyl ether, p-tert-butylphenyl glycidyl ether, o-cresyl glycidyl ether, p-nonylphenyl glycidyl ether, octyl glycidyl ether, decyl glycidyl ether, dodecyl glycidyl ether, tetradecyl glycidyl ether, 1,4-butanediol diglycidyl ether, 1,6-hexanediol diglycidyl ether, 2-methyl-1,3-propanediol diglycidyl ether, 1,3-propanediol diglycidyl ether, polypropylene glycol diglycidyl ether, neopentyl glycol diglycidyl ether, ethylene glycol diglycidyl ether, propylene glycol diglycidyl ether, diethylene glycol diglycidyl ether, dipropylene glycol diglycidyl ether, triethylene glycol diglycidyl ether, tripropylene glycol diglycidyl ether, 1,4-cyclohexanedimethanol diglycidyl ether, 1,3-cyclohexanedimethanol diglycidyl ether, bisphenol A diglycidyl ether, bisphenol F diglycidyl ether, and the like, and mixtures thereof.

Glycidyl esters and diglycidyl esters having boiling points of at least 200° C., preferably at least 250° C., at 760 mm Hg are also suitable for use in the inventive polyol blends. Suitable glycidyl esters or diglycidyl esters include reaction products of mono- or dicarboxylic acids or their salts with epichlorohydrin. Some glycidyl esters or diglycidyl esters are commercially available. For instance, glycidyl esters supplied by from Hexion under the Cardura™ mark, such as Cardura™ E10P glycidyl ester, are suitable for use. Other suitable glycidyl esters or diglycidyl esters can be synthesized by well-known methods such as those described in U.S. Pat. Nos. 2,448,602; 2,567,842; 3,053,855; 3,075,999; 3,178,454; 3,859,314; 3,957,831; 6,453,217; and 8,802,872, and U.S. Publ. No. 2014/0316030, the teachings of which are incorporated herein by reference. Suitable glycidyl esters or diglycidyl esters include, for example, glycidyl 2-ethylhexanoate, glycidyl nonanoate, glycidyl neodecanoate, glycidyl benzoate, glycidyl laurate, diglycidyl adipate, diglycidyl azelate, diglycidyl sebacate, and the like, and mixtures thereof.

The polyol blends include 1 to 20 wt. %, based on the amount of polyol blend, of the glycidyl compound. In some aspects, the blends include 5 to 15 wt. % or 7 to 10 wt. % of the glycidyl compound. The amount of glycidyl compound actually used will depend on the desired viscosity of the polyol blend, the desired level of chain extension, the identity of the glycidyl compound, the nature and proportion of the aliphatic or aromatic polyester polyol used, the nature and proportion of the sugar used, the intended end-use application, and other factors that are within the skilled person's discretion.

The blends can be formulated by any desired method or order of combining the components. Often, it is convenient to add the glycidyl compound and the sugar to the polyester polyol after the polyester polyol has been made and is still warm. Thus, the polyol at 60° C. to 150° C., 80° C. to 130° C., or 90° C. to 120° C. is conveniently combined with the desired amounts of the glycidyl compound and sugar components, and the resulting mixture is blended until homogeneous, usually for 5 minutes to 2 hours, or 20 minutes to 1 hour.

The polyol blends are generally easy to process. In some aspects, the polyol blends will have a viscosity at 75° C. less than 2000 cP, preferably less than 1000 cP, and more preferably less than 500 cP. In other aspects, the polyol blends will have a viscosity at 25° C. less than 10,000 cP, preferably less than 5000 cP, and more preferably less than 1000 cP.

The table below lists boiling points of some suitable glycidyl compounds used in the inventive polyol blends. As will be apparent to the skilled person, most of these compounds would require reduced pressure distillation to avoid substantial decomposition or destruction of the material.

| | Boiling point at |
|---|---|
| Glycidyl compound | 760 mm (° C.) |
| 2-ethylhexyl glycidyl ether | 257 |
| 1,4-butanediol diglycidyl ether | 260-266 |
| 1,6-hexanediol diglycidyl ether | 329 |
| benzyl glycidyl ether | 257 |
| phenyl glycidyl ether | 245 |
| p-tert-butylphenyl glycidyl ether | 300 |
| p-nonylphenyl glycidyl ether | 383 |
| o-cresyl glycidyl ether | 268 |
| dodecyl glycidyl ether | 303 |
| octyl/decyl glycidyl ether | 261 |
| neopentyl glycol diglycidyl ether | 301 |
| dipropylene glycol diglycidyl ether | 313-330 |
| cyclohexane 1,4-dimethanol diglycidyl ether | 448 |
| glycidyl neodecanoate | 251-278 |
| glycidyl 2-ethylhexanoate | 262 |
| glycidyl benzoate | 240 |
| glycidyl laurate | 300 |

The hydroxyl number of the polyol blend can vary and will depend on the intended end use. For example, a blend intended for a rigid polyurethane foam will generally have a higher hydroxyl number than a blend intended for a 2K polyurethane coating. In some aspects, the polyol blend will have a hydroxyl number within the range of 25 to 800 mg KOH/g, 50 to 400 mg KOH/g, 100 to 300 mg KOH/g, or 150 to 200 mg KOH/g.

The polyol blends can be used in combination with other conventional components used to produce thermoset polymers such as other polyols, chain extenders, crosslinkers, fillers, viscosity reducers, thixotropic agents, flow-control agents, pigments, antioxidants, antimicrobial agents, flame retardants, catalysts, free-radical initiators, foaming agents, surfactants, defoamers, and the like, and combinations thereof.

II. Coatings from the Polyol Blends

In one aspect, the invention relates to a polymer coating produced using the polyol blends described above. In other aspects, the polymer coating is produced from a polyester polyol/sugar blend (without any glycidyl or diglycidyl ether component) as is described further below. A variety of polymer coatings can be made that take advantage of the ability to crosslink or chain extend the hydroxyl groups present in the sugar and polyester polyol components of the polyol blends. For instance, the blends can be reacted with melamine resins or polyisocyanates.

In one aspect, the polymer coating is a two-component (2K) polyurethane coating made from an inventive polyester polyol blend and one or more diisocyanates or a diisocyanate trimer. Examples of how to prepare and test two-component polyurethane coatings of this type are provided below. Briefly, when a diisocyanate or diisocyanate blend is used, the polyol blend is conveniently diluted with a solvent or solvent mixture, then combined with a diisocyanate or mixture of diisocyanates. For instance, a mixture of hexamethylene diisocyanate (HDI) and isophorone diisocyanate (IPDI) is conveniently used. The reaction can be catalyzed, especially by an organotin catalyst such as stannous octoate or dibutyltin dilaurate. The reaction mixture can then be coated onto a surface and cured to give the 2K polyurethane coating. When a diisocyanate trimer (e.g., HDI trimer) or mixture of diisocyanate trimers is used instead of the diisocyanate mixture, the same or similar procedure for making the 2K polyurethane coating can be followed. An example appears further below.

In another aspect, the polymer coating is a moisture-cured polyurethane. In this case, the polyol blend is combined with enough of a polyisocyanate or mixture of polyisocyanates to give a prepolymer having some residual free NCO content, typically 1 to 5 wt. % or 1 to 3 wt. %. The prepolymer is applied to a surface and is allowed to cure using atmospheric moisture. The curing can occur under ambient conditions. In some cases, it will be more desirable to cure the coating at elevated temperature, under controlled moisture conditions, or some combination of these.

III. Polymer Coatings from Polyol/Sugar Blends

In some aspects, the invention relates to polymer coatings made from a blend of an aliphatic or aromatic polyester polyol and a sugar. The coatings are described above. For these coatings, a blend of an aliphatic or aromatic polyester polyol and a sugar is used, but no glycidyl or diglycidyl ether is included.

In particular, the polyol blends comprise 90 to 99.9 wt. % of an aromatic or aliphatic polyester polyol and 0.1 to 10 wt. % of a sugar having an average hydroxyl functionality of 4 to 6 and a melting point less than 125° C.

In some aspects, the coating comprises a two-component polyurethane coating made from the polyol blend and one or more diisocyanates or a diisocyanate trimer. Suitable procedures for making two-component polyurethane coatings from polyester polyol/sugar blends are described above and in the examples below.

In some aspects, the polymer coating comprises 0.3 to 5 wt. %, or 0.5 to 3 wt. %, of the sugar.

### IV. Other Applications for the Polyol Blends

The inventive polyol blends are particularly valuable for formulating polyurethane coatings. However, the blends can also be used as minor or principal components of flexible, semi-rigid, and rigid polyurethane and polyisocyanurate foams, adhesives, sealants, and elastomers. The blends can be used to formulate aqueous polyurethane dispersions, acrylate-tipped polyols useful for radiation-cured coatings, and as intermediates for making other polyester polyols. The blends can also be used as reactants for formulating unsaturated polyester resins that can be diluted with styrene and cured with free-radical initiators.

The following examples merely illustrate the invention; the skilled person will recognize many variations that are within the spirit of the invention and scope of the claims.

Polyol Blend A: Digested rPET Polyol, Sorbitol and Glycidyl Ether

A reactor equipped with an overhead mixer, condenser, heating mantle, thermocouple, and nitrogen inlet is charged with recycled polyethylene terephthalate (2185.8 g), pentaerythritol (100.9 g), and propylene glycol (993.2 g). The mixture is heated and stirred until the reactor contents reach 200° C. Titanium(IV) butoxide (4.8 g) is charged to the mixture when the reaction temperature reaches 100° C. The mixture is heated until no particles of recycled PET remain (about 7 h). When the digestion reaction is considered complete, the mixture is cooled to about 100° C. Succinic acid (868.4 g) and sebacic acid (218.6 g) are added, and the mixing rate is increased (300 rpm). The reflux condenser is replaced with a silver vacuum-jacketed, 5-stage separation column, a short-path distillation head, and receiving flask. Heating to 200° C. is resumed. Water generated in the condensation reaction is removed until roughly the theoretical amount is removed. When the reaction is complete, and acid value is less than 2 mg KOH/g polyol, the product is allowed to cool to 100° C. Sorbitol (72.1 g) and 2-ethylhexyl glycidyl ether (Erisys™ GE-6, product of Emerald Performance Materials, 360.3 g) are blended with the polyol for 0.5 h or until the material appears homogeneous. The polyol blend (about 4500 g) is then decanted from the reactor and filtered.

Hydroxyl numbers and acid numbers are determined by standard methods (DIN 53240-2 and ASTM D4662, respectively). Viscosities are measured at 75° C. using a Brookfield DV-III Ultra Rheometer with spindle #31 at 50% torque.

### 2K Polyurethane Coatings (Diisocyanate Blend)

Polyester polyol blend A (11.6 g), prepared as described above, is heated in a beaker and is diluted with 2-butanone (7.5 g) and propylene glycol methyl ether acetate (7.5 g). The mixture is stirred mechanically with gentle warming to obtain a homogeneous mixture. Hexamethylene diisocyanate (2.20 g) and isophorone diisocyanate (1.25 g) are added and mixed until homogeneous. Dibutyltin dilaurate (7.5 mg) is then added. After light mixing for 30 s, a bead of the reaction mixture is applied to one side of three aluminum panels (4″×6″) and one cold-rolled steel panel (4″×12″). The beads of solvent-borne polyurethane are drawn down each panel into a wet film using a #50 R.D. Specialties bar to a wet-film thickness of 4.5 mils. The panels are allowed to flash dry in a hood at ambient temperature for at least 15 min., then placed in a 130° C. oven for 30 min. to complete conversion to the polyurethane. The panels are cured in a humidity chamber (25° C., 50% relative humidity) for 12 h before testing.

### 2K Polyurethane Coatings (HDI Trimer)

The procedure used above is generally followed except that HDI trimer replaces the diisocyanate blend. Thus, polyester polyol blend A (9.24 g) is heated in a beaker and is diluted with 2-butanone (7.5 g) and propylene glycol methyl ether acetate (7.5 g). The mixture is stirred mechanically with gentle warming to obtain a homogeneous mixture. Vestanat® HT 2500/100 (HDI trimer, product of Evonik, 5.75 g) is added and mixed until homogeneous. Dibutyltin dilaurate (7.5 mg) is then added, mixed for 30 s, the reaction mixture is applied to aluminum or cold-rolled steel panels, and the resulting coatings are cured as described earlier.

### Testing Methods:

Dry film thickness: determined using a PosiTector® 6000 (Defelsko Corporation) dry film thickness gauge. Konig hardness: ISO 1522, TQC pendulum hardness tester (Model SPO500). Pencil scratch hardness: ASTM D3363. Flexibility: ASTM D522. Adhesion: ASTM D3359. Stain testing: ASTM D1308. MEK double rubs: ASTM D4752. Impact testing on cold-rolled steel panels: ASTM D2794.

As shown in Table 1 (below), good two-component polyurethane coatings can be made using either HDI/IPDI or HDI trimer as the crosslinking agent from Polyol Blend A, i.e., a blend of a polyester polyol made from recycled polyethylene terephthalate, sorbitol (1.5 wt. %) and 2-ethylhexyl glycidyl ether (7.5 wt. %).

TABLE 1
Two-Component Polyurethane Coating Results from Polyol Blend A

| | Example | | | |
|---|---|---|---|---|
| | 1 | 2 | 3 | 4 |
| Polyol Blend | A | A | A | A |
| 2K Coating Type | HDI/IPDI | HDI/IPDI | HDI trimer | HDI trimer |
| Film description | clear | clear | clear | clear |
| DFT | 1.60 | 1.65 | 1.48 | 1.52 |
| König oscillations | 134 | 135 | 144 | 143 |
| König seconds | 189 | 190 | 202 | 201 |
| Pencil hardness | HB | B | HB | HB |
| Adhesion | 5B | 5B | 5B | 5B |
| Mandrel bend, ⅛″ | pass | pass | pass | pass |
| Mandrel bend, ¼″ | pass | pass | pass | pass |
| Windex ® cleaner spot, 1 h, | 5 | 5 | 5 | 5 |
| and 1 h recovery | 5 | 5 | 5 | 5 |
| 50% EtOH spot, 1 h, and | 5 | 5 | 5 | 5 |
| 1 h recovery | 5 | 5 | 5 | 5 |
| Vinegar spot, 1 h, and 1 h | 5 | 5 | 5 | 5 |
| recovery | 5 | 5 | 5 | 5 |
| Water spot, 24 h, and 1 h | 4 | 4 | 5 | 5 |
| recovery | 5 | 5 | 5 | 5 |
| MEK double rubs | 108 | 129 | 203 | 204 |
| Direct impact, in.-lb. | >160 | >160 | >160 | >160 |
| Indirect impact, in.-lb. | >160 | >160 | >160 | >160 |

2K Polyurethane Coatings from Polyol Blend a Versus Other Blends:

Two-component polyurethane coatings are prepared using HDI trimer and a series of polyol blends. Polyol Blend A is prepared as described previously with polyester polyol plus 1.5 wt. % sorbitol and 7.5 wt. % of 2-ethylhexyl glycidyl ether. “Blend” B is the polyester polyol from Blend A without any sorbitol or 2-ethylhexyl glycidyl ether present. Blend C is the polyester polyol from Blend A plus 7.5 wt. % of 2-ethylhexyl glycidyl ether only (i.e., no sorbitol added). Blend D is the polyester polyol from Blend A plus 1.5 wt. % of sorbitol only (i.e., no 2-ethylhexyl glycidyl ether added). Table 2 summarizes results of analysis of the resulting 2K polyurethane coatings.

TABLE 2
Two-Component Polyurethane Coating Results

| | Example | | | |
|---|---|---|---|---|
| | 5 | C6 | C7 | C8 |
| Polyol Blend | A | B | C | D |
| Polyester polyol plus . . . | 1.5% | none | 7.5% GE-6 | 1.5% |
| | sorbitol; | | | sorbitol |
| | 7.5% GE-6 | | | |
| 2K Coating Type | HDI trimer | HDI trimer | HDI trimer | HDI trimer |
| Film description | clear | clear | clear | clear |
| König oscillations | 153 | 99 | 104 | 130 |
| König seconds | 215 | 138 | 146 | 183 |
| Pencil hardness | F | 2B | B | HB |
| Adhesion | 4B | 0B | 0B | 1B |
| Mandrel bend, ⅛″ | pass | fail | fail | pass |
| Mandrel bend, ¼″ | pass | fail | pass | pass |
| Windex ® cleaner spot, 1 h, | 5 | 5 | 5 | 5 |
| and 1 h recovery | 5 | 5 | 5 | 5 |
| 50% EtOH spot, 1 h, and | 5 | 5 | 5 | 5 |
| 1 h recovery | 5 | 5 | 5 | 5 |
| Vinegar spot, 1 h, and 1 h | 5 | 5 | 5 | 5 |
| recovery | 5 | 5 | 5 | 5 |
| Water spot, 24 h, and 1 h | 5 | 5 | 5 | 5 |
| recovery | 5 | 5 | 5 | 5 |
| MEK double rubs | 112 | 100 | 75 | 109 |
| Direct impact, in.-lb. | >160 | <10 | 10 | >160 |
| Indirect impact, in.-lb. | >160 | <10 | 10 | >160 |

As shown in Table 2, the coating from Blend A has the best combination of hardness, flexibility, adhesion, solvent resistance, and impact resistance. The coating from Blend D (with sorbitol) is reasonably good, but it lacks acceptable adhesion.

### Polyol Blends E, F, and G

Polyol Blend E is produced as in Polyol Blend A except that 1 wt. % sorbitol is used instead of 1.5 wt. %, and no 2-ethylhexyl glycidyl ether is included. Polyol Blends F and G are made with 3 or 5 wt. % sorbitol, respectively, and no 2-ethylhexyl glycidyl ether.

2K Polyurethane Coatings from Polyol/Sorbitol Blends

Two-component polyurethane coatings are prepared using HDI trimer and a series of polyol/sorbitol blends. The control is the polyol used for Blend A but without any sorbitol or 2-ethylhexyl glycidyl ether included. Blend E is the polyester polyol from Blend A with 1 wt. % sorbitol and no 2-ethylhexyl glycidyl ether present. Blends F and G are made with 3 or 5 wt. % sorbitol, respectively, and no 2-ethylhexyl glycidyl ether. Table 3 summarizes results of analysis of the resulting 2K coatings.

TABLE 3
Two-Component Polyurethane Coating Results

| | | Example | | |
|---|---|---|---|---|
| | | 9 | 10 | 11 |
| Polyol Blend | control | E | F | G |
| Polyester polyol plus . . . | no sorbitol | 1 wt. % | 3 wt. % | 5 wt. % |
| | | sorbitol | sorbitol | sorbitol |
| 2K Coating Type | HDI trimer | HDI trimer | HDI trimer | HDI trimer |
| Hydroxyl value, mg | 154 | 171 | 197 | 229 |
| KOH/g | | | | |
| Viscosity, cP, 75° C. | 5654 | 5819 | 6509 | 9208 |
| Film description | clear | clear | particulates | particulates |
| König oscillations | 149 | 155 | 154 | 155 |
| König seconds | 210 | 217 | 216 | 218 |
| Pencil hardness | 8 | 8 | 8 | 7 |
| Adhesion | 3 | 5 | 4 | 3 |
| Mandrel bend, ⅛″ | pass | pass | pass | pass |
| Mandrel bend, ¼″ | pass | pass | pass | pass |
| Windex ® cleaner spot, 1 h, | 5 | 5 | 5 | 5 |
| and 1 h recovery | 5 | 5 | 5 | 5 |
| 50% EtOH spot, 1 h, and | 5 | 5 | 5 | 5 |
| 1 h recovery | 5 | 5 | 5 | 5 |
| Vinegar spot, 1 h, and 1 h | 5 | 5 | 5 | 5 |
| recovery | 5 | 5 | 5 | 5 |
| Water spot, 24 h, and 1 h | 5 | 5 | 5 | 5 |
| recovery | 5 | 5 | 5 | 5 |
| MEK double rubs | 126 | 191 | 198 | >200 |
| Direct impact, in.-lb. | >160 | <10 | 10 | >160 |
| Indirect impact, in.-lb. | >160 | <10 | 10 | >160 |

As shown in Table 3, excellent 2K polyurethane coatings can be made from a polyester polyol and 1 wt. % sorbitol. With increasing amounts of sorbitol (3-5 wt. %), the coatings have improved properties, but some particulates are noticed in the films. Additionally, the higher hydroxyl numbers imply a higher polyisocyanate demand, and the higher viscosities may pose some formulation challenges.

Polyol Blend H: Digested rPET Polyol, Sorbitol and Glycidyl Ether

A reactor equipped with an overhead mixer, condenser, heating mantle, thermocouple, and nitrogen inlet is charged with recycled polyethylene terephthalate (1347 g, 27.0 wt. %), poly(bisphenol A) carbonate (399 g, 8.0 wt. %), polyethylene glycol 200 (1428 g, 28.43 wt. %), diethylene glycol (476 g, 9.81 wt. %), and glycerol (223 g, 3.98 wt. %). The mixture is heated and stirred until the reactor contents reach 200° C. Monobutyltin hydroxide oxide hydrate (“MTBO,” 5.0 g, 0.1 wt. %) is charged to the mixture when the reaction temperature reaches 100° C. The mixture is heated until no particles of recycled PET remain (about 7 h). When the digestion reaction is considered complete, the mixture is cooled to about 100° C. Adipic acid (162 g, 3.68 wt. %), phthalic anhydride (499 g, 10.0 wt. %), and soybean oil (449 g, 9.0 wt. %) are added, and the mixing rate is increased (300 rpm). The reflux condenser is replaced with a silver vacuum-jacketed, 5-stage separation column, a short-path distillation head, and receiving flask. Heating to 200° C. is resumed. Water generated in the condensation reaction is removed until roughly the theoretical amount is removed. When the reaction is complete, and acid value is less than 2 mg KOH/g polyol, the product is allowed to cool to 100° C. Yield: 4800 g. Hydroxyl value: 264 mg KOH/g; viscosity (25° C.) 6011 cP; Gardner color: 2; appearance: light amber liquid.

Sorbitol (156 g, 3.0 wt. %) and 2-ethylhexyl glycidyl ether (Erisys™ GE-6, 261 g, 5.0 wt. %) are blended with the polyol for 0.5 h or until the material appears homogeneous. The polyol blend is then decanted from the reactor and filtered.

### 2K Polyurethane Coatings (HDI Trimer)

Two-component polyurethane coatings from polyol blends are prepared using HDI trimer as previously described. “Blend” J is the polyester polyol from Blend H without any sorbitol or 2-ethylhexyl glycidyl ether present. Blend K is the polyester polyol from Blend H plus 5.0 wt. % of 2-ethylhexyl glycidyl ether only (i.e., no sorbitol added). Blend L is the polyester polyol from Blend H plus 3.0 wt. % of sorbitol only (i.e., no 2-ethylhexyl glycidyl ether added). Results appear in Table 4.

TABLE 4
Two-Component Polyurethane Coating Results

| | Example | | | |
|---|---|---|---|---|
| | 12 | C13 | C14 | C15 |
| Polyol Blend | H | J | K | L |
| Polyester polyol plus . . . | 3.0% | none | 5.0% GE-6 | 3.0% |
| | sorbitol; | | | sorbitol |
| | 5.0% GE-6 | | | |
| Hydroxyl value (mg | 292 | 268 | 259 | 296 |
| KOH/g) | | | | |
| Viscosity at 25° C. (cP) | 3592 | 6520 | 3218 | 6461 |
| 2K Coating Type | HDI trimer | HDI trimer | HDI trimer | HDI trimer |
| Film description | smooth, | some | some | grainy |
| | normal | bubbles | bubbles | |
| König oscillations | 73 | 34 | 55 | 74 |
| König seconds | 103 | 48 | 77 | 104 |
| Pencil hardness | 2B | HB | F | F |
| Adhesion | 5B | 0B | 1B | 5B |
| Mandrel bend, ⅛″ | pass | pass | pass | pass |
| Mandrel bend, ¼″ | pass | pass | pass | pass |
| Windex ® cleaner spot, 1 h, | 5 | 5 | 5 | 5 |
| and 1 h recovery | 5 | 5 | 5 | 5 |
| 50% EtOH spot, 1 h and | 4 | 5 | 4 | 4 |
| 1 h recovery | 4 | 5 | 4 | 4 |
| Vinegar spot, 1 h, and 1 h | 5 | 5 | 5 | 5 |
| recovery | 5 | 5 | 5 | 5 |
| Water spot, 24 h, and 1 h | 5 | 5 | 5 | 5 |
| recovery | 5 | 5 | 5 | 5 |
| MEK double rubs | 118 | 163 | 85 | 148 |
| Direct impact, in.-lb. | 160 | 160 | 160 | 160 |
| Indirect impact, in.-lb. | 160 | 160 | 160 | 160 |

As shown in Table 4, sorbitol alone is able to boost properties of the polyester polyol-based coating, but viscosity of the polyol/sorbitol blend is high, and the resulting film is grainy. However, combination of the polyester polyol with both sorbitol with 2-ethylhexyl glycidyl ether reduces the polyol blend viscosity significantly and also provides a high-quality polyurethane film.

Polyol Blend M: Digested rPET Polyol, Sorbitol and Glycidyl Ether

A reactor equipped with an overhead mixer, condenser, heating mantle, thermocouple, and nitrogen inlet is charged with recycled polyethylene terephthalate (1507 g, 30.0 wt. %), polyethylene glycol 200 (1366 g, 27.2 wt. %), diethylene glycol (658 g, 13.09 wt. %), and glycerol (225 g, 4.47 wt. %). The mixture is heated and stirred until the reactor contents reach 200° C. titanium(IV) butoxide (5.0 g, 0.1 wt. %) is charged to the mixture when the reaction temperature reaches 100° C. The mixture is heated until no particles of recycled PET remain (about 7 h). When the digestion reaction is considered complete, the mixture is cooled to about 100° C. Adipic acid (57 g, 1.14 wt. %), phthalic anhydride (754 g, 15.0 wt. %), and soybean oil (452 g, 9.0 wt. %) are added, and the mixing rate is increased (300 rpm). The reflux condenser is replaced with a silver vacuum-jacketed, 5-stage separation column, a short-path distillation head, and receiving flask. Heating to 200° C. is resumed. Water generated in the condensation reaction is removed until roughly the theoretical amount is removed. When the reaction is complete, and acid value is less than 2 mg KOH/g polyol, the product is allowed to cool to 100° C. Yield: 4800 g. Hydroxyl value: 248 mg KOH/g; viscosity (25° C.) 5733 cP; Gardner color: 1; appearance: light amber liquid.

Sorbitol (156 g, 3.0 wt. %) and 2-ethylhexyl glycidyl ether (Erisys™ GE-6, 261 g, 5.0 wt. %) are blended with the polyol for 0.5 h or until the material appears homogeneous. The polyol blend is then decanted from the reactor and filtered.

### 2K Polyurethane Coatings (HDI Trimer)

Two-component polyurethane coatings from polyol blends are prepared using HDI trimer as previously described. “Blend” N is the polyester polyol from Blend M without any sorbitol or 2-ethylhexyl glycidyl ether present. Blend P is the polyester polyol from Blend M plus 5.0 wt. % of 2-ethylhexyl glycidyl ether only (i.e., no sorbitol added). Blend Q is the polyester polyol from Blend M plus 3.0 wt. % of sorbitol only (i.e., no 2-ethylhexyl glycidyl ether added). Results appear in Table 5.

TABLE 5
Two-Component Polyurethane Coating Results

| | Example | | | |
|---|---|---|---|---|
| | 16 | C17 | C18 | C19 |
| Polyol Blend | M | N | P | Q |
| Polyester polyol plus . . . | 3.0% | none | 5.0% GE-6 | 3.0% |
| | sorbitol; | | | sorbitol |
| | 5.0% GE-6 | | | |
| Hydroxyl value (mg | 280 | 254 | 254 | 261 |
| KOH/g) | | | | |
| Viscosity at 25° C. (cP) | — | 5777 | 3116 | 7814 |
| 2K Coating Type | HDI trimer | HDI trimer | HDI trimer | HDI trimer |
| Film description | smooth, | bubbles | some | some |
| | normal | | bubbles | bubbles |
| König oscillations | 60 | 20 | 54 | 65 |
| König seconds | 84 | 28 | 75 | 91 |
| Pencil hardness | HB | HB | F | HB |
| Adhesion | 4B | 0B | 4B | 5B |
| Mandrel bend, ⅛″ | pass | pass | pass | pass |
| Mandrel bend, ¼″ | pass | pass | pass | pass |
| Windex ® cleaner spot, 1 h, | 3 | 5 | 5 | 5 |
| and 1 h recovery | 3 | 5 | 5 | 4 |
| 50% EtOH spot, 1 h and | 4 | 5 | 4 | 4 |
| 1 h recovery | 4 | 5 | 4 | 4 |
| Vinegar spot, 1 h, and 1 h | 5 | 5 | 5 | 5 |
| recovery | 5 | 5 | 5 | 5 |
| Water spot, 24 h, and 1 h | 5 | 5 | 5 | 5 |
| recovery | 5 | 5 | 5 | 5 |
| MEK double rubs | 137 | 108 | 67 | 118 |
| Direct impact, in.-lb. | 160 | 160 | 160 | 160 |
| Indirect impact, in.-lb. | 160 | 160 | 160 | 160 |

As shown in Table 5, sorbitol alone is able to boost properties of the polyester polyol-based coating, but viscosity of the polyol/sorbitol blend is high, and the resulting film has imperfections. However, combination of the polyester polyol with both sorbitol with 2-ethylhexyl glycidyl ether reduces the polyol blend viscosity significantly and also provides a high-quality polyurethane film.

The preceding examples are meant only as illustrations; the following claims define the inventive subject matter.

We claim:

1. A polyol blend comprising:
(a) 70 to 99 wt. % of an aromatic or aliphatic polyester polyol;
(b) 0.1 to 10 wt. % of a sugar having an average hydroxyl functionality of 4 to 6 and a melting point less than 125° C.; and
(c) 1 to 20 wt. % of a glycidyl compound selected from the group consisting of glycidyl ethers, diglycidyl ethers, glycidyl esters, diglycidyl esters, and mixtures thereof, wherein the glycidyl compound has a boiling point of at least 200° C. at 760 mm Hg.

2. The blend of claim 1 wherein the polyester polyol comprises a glycol-digested thermoplastic polyester.

3. The blend of claim 2 wherein the polyester polyol comprises a glycol-digested, recycled polyethylene terephthalate.

4. The blend of claim 1 comprising 80 to 95 wt. % of the polyester polyol.

5. The blend of claim 1 wherein the sugar is selected from the group consisting of sorbitol, fructose, xylitol, meso-erythritol, arabitol, glucosamine, lyxose, rhamnose, ribose, and ribitol.

6. The blend of claim 1 wherein the sugar is selected from the group consisting of sorbitol, fructose, xylitol, meso-erythritol.

7. The blend of claim 1 wherein the sugar is sorbitol.

8. The blend of claim 1 comprising 0.5 to 5 wt. % of the sugar.

9. The blend of claim 1 wherein the glycidyl compound has a boiling point of at least 250° C.

10. The blend of claim 1 wherein the glycidyl compound is a glycidyl or diglycidyl ether selected from the group consisting of 2-ethylhexyl glycidyl ether, phenyl glycidyl ether, benzyl glycidyl ether, p-tert-butylphenyl glycidyl ether, o-cresyl glycidyl ether, p-nonylphenyl glycidyl ether, octyl glycidyl ether, decyl glycidyl ether, dodecyl glycidyl ether, tetradecyl glycidyl ether, 1,4-butanediol diglycidyl ether, 1,6-hexanediol diglycidyl ether, 2-methyl-1,3-propanediol diglycidyl ether, 1,3-propanediol diglycidyl ether, polypropylene glycol diglycidyl ether, neopentyl glycol diglycidyl ether, ethylene glycol diglycidyl ether, propylene glycol diglycidyl ether, diethylene glycol diglycidyl ether, dipropylene glycol diglycidyl ether, triethylene glycol diglycidyl ether, tripropylene glycol diglycidyl ether, 1,4-cyclohexanedimethanol diglycidyl ether, 1,3-cyclohexanedimethanol diglycidyl ether, bisphenol A diglycidyl ether, bisphenol F diglycidyl ether, and mixtures thereof.

11. The blend of claim 1 wherein the glycidyl compound is a glycidyl or diglycidyl ester selected from the group consisting of glycidyl 2-ethylhexanoate, glycidyl nonanoate, glycidyl neodecanoate, glycidyl benzoate, glycidyl laurate, diglycidyl adipate, diglycidyl azelate, diglycidyl sebacate, and mixtures thereof.

12. The blend of claim 1 comprising 5 to 15 wt. % of the glycidyl compound.

13. A polymer coating made from the polyol blend of claim 1.

14. The polymer coating of claim 13 comprising a two-component polyurethane coating made from the polyol blend and one or more diisocyanates or diisocyanate trimers.

15. A moisture-cured polyurethane coating of claim 13.

16. A polymer coating made from a polyol blend comprising
(a) 90 to 99.9 wt. % of an aromatic or aliphatic polyester polyol;
(b) 0.1 to 10 wt. % of a sugar having an average hydroxyl functionality of 4 to 6 and a melting point less than 125° C.

17. The polymer coating of claim 16 comprising a two-component polyurethane coating made from the polyol blend and one or more diisocyanates or a diisocyanate trimer.

18. The polymer coating of claim 16 comprising 0.3 to 5 wt. % of the sugar.

19. The polymer coating of claim 16 comprising 0.5 to 2 wt. % of the sugar.

20. A rigid polyurethane or polyisocyanurate foam prepared from the polyol blend of claim 1.

21. A flexible polyurethane foam prepared from the polyol blend of claim 1.

22. A polyurethane adhesive prepared from the polyol blend of claim 1.

23. An acrylate or urethane acrylate prepared from the polyol blend of claim 1.

24. A polyurethane dispersion prepared from the polyol blend of claim 1.
